(19) United States
(12) Patent Application Publication
(10) Pub. No.: US 2023/0055483 A1
(43) Pub. Date: Feb. 23, 2023

(54) DISCHARGING OR CHARGING OF BATTERY MODULES

(71) Applicant: Scubajet Gmbh, Klagenfurt am Wörthersee (AT)

(72) Inventor: Armin KUNDIGRABER, Maria Rain (AT)

(21) Appl. No.: 17/755,160

(22) PCT Filed: Oct. 24, 2019
(86) PCT No.: PCT/AT2019/060353

§ 371 Date: May 3, 2022

(51) Int. Cl. H01M 10/44; H01M 10/48; H01M 10/42

(52) U.S. Cl. CPC H01M 10/441; H01M 10/482; H01M 10/425; H01M 2010/4271

(57) ABSTRACT

A method for controlling the discharging or charging of a group of one or more battery modules able to be interconnected in parallel, wherein the module voltages of the battery modules are ascertained and a highest or lowest module voltage is ascertained from the ascertained module voltages and only battery modules whose module voltage differs from the highest or lowest module voltage by less than a predefined activation difference are interconnected, and a battery module for use in a group of at least two battery modules able to be interconnected in parallel, wherein the battery module has at least one power connection and a battery unit connected thereto via a switch, wherein the battery module furthermore has a voltmeter for measuring the voltage of the battery unit and a module controller connected to the voltmeter and the switch, wherein the module controller has at least one data bus connection and is designed, in the event of connection to a data bus, to provide a voltage ascertained by the voltmeter on the data bus and to open the switch in response to a control command received on the data bus.

The invention relates to a method for controlling the discharging and an analogous method for controlling the charging of a group of one or more battery modules interconnectable in parallel, wherein the module voltages of the battery modules are determined. The invention further relates to a battery module for use in a group of at least two battery modules interconnectable in parallel, wherein the battery module has at least one power connection and a battery unit connected thereto via a switch, wherein the battery module furthermore has a voltage measuring device for measuring the voltage of the battery unit, as well as a group of at least two such battery modules. Finally the invention also relates to a corresponding load module for connection to a group of one or more battery modules interconnectable in parallel, wherein the load module has power connections and an electrical load connected thereto, and analogously a corresponding charging device for connection to a group of one or more battery modules interconnectable in parallel, wherein the charging device has power connections and an electrical voltage source connected thereto.

For safety reasons it is desirable to limit the energy content of a transport unit with rechargeable batteries (“rechargeable batteries”). In order nevertheless to be able to provide a battery with a higher energy content, it is known to design the battery as divisible into battery modules which can each be transported as a transport unit separately from one another.

Such a battery comprising a plurality of battery modules in the form of cell strands connected in parallel is known from DE 10 2012 2015 244 A1. In this case, on the one hand the voltage of the entire battery unit, i.e. over all the cell strands is monitored and, for example, in the event of an overvoltage a charging current is interrupted or in the event of an undervoltage, a current flow to the load is interrupted. In these situations, the entire battery unit is therefore disconnected. DE 10 2012 205 244 A1 further discloses a monitoring of the voltage of individual cell strands to detect functional disturbances. An individual switching of the cell strands depending on the respective strand voltage is not disclosed.

US 2012/0268057 A1 discloses a method for controlling the discharging or charging of individual battery cells within a cell strand of battery cells connected in series. In this case, the voltages of the individual battery cells are measured and during charging the battery cell having the highest voltage is connected in parallel with an additional equalizing cell in order to lower the charging current and therefore the charging speed of the relevant battery cell. If the highest cell voltage reaches an upper limiting value, the entire cell strand is switched off and the charging current interrupted. Conversely during discharging the battery cell with the lowest voltage is connected in parallel with the additional equalizing cell in order to thereby reduce the discharging rate of the relevant battery cell. When the lowest cell voltage has reached a lower limiting value, the entire cell strand is again disconnected from the electrical load. A control at the level of the cell strands, i.e., on the basis of individual strand voltages is not disclosed.

It is an object of the invention to avoid or at least reduce equalizing currents between the battery modules of a modular battery.

The invention provides a method for controlling the discharging of the kind mentioned initially, wherein a highest module voltage is determined from the determined module voltages and only those battery modules whose module voltage differs from the highest module voltage by less than a predefined activation difference are interconnected. The activation difference can in this case be a predefined absolute value of a voltage difference or a relative value e.g., related to the determined module voltages or the highest module voltages. The proposed method can already be applied to only one battery module. The method naturally only influences the sequence of the discharging from at least two battery modules which is why the method, in particular the control of the discharging, relates to a group of at least two battery modules interconnectable in parallel. As a result of the fact that only battery modules having a voltage difference less than the activation difference are interconnected, the equalizing current between the battery modules is limited according to this voltage difference and proportional to the internal resistance of the battery modules. During discharging therefore, beginning with the battery module having the highest module voltages, the individual battery modules are gradually connected as soon as the already active (interconnected) battery modules have reached their individual module voltages so that at the end of discharging all the battery modules have substantially the same module voltages and are interconnected.

The module voltages and on this basis the interconnected battery modules can be re-determined at regular intervals. For example, the battery modules can independently report their module voltages to a group controller at regular intervals, which controller then determines the interconnected battery modules and controls them accordingly (i.e., switches the battery module according to module voltage for connection to or separation from an electrical consumer). Alternatively, a group controller could request the module voltages at regular intervals and after receiving all the responses, determine the interconnected battery modules and control them accordingly.

According to an optional variant of the method, the predefined activation difference can be less than 1%, in particular less than 0.5% of the nominal voltage of a battery module. For example, at a nominal voltage of 33.3 V, the predefined activation difference can be an absolute value of 0.1 V. This corresponds to approximately 0.3% of the nominal voltage and is therefore within the range specified above for the activation difference. According to this, an absolute value of 0.3 V at the same nominal voltage would also be within this range. The activation difference can alternatively also be predefined as a relative value, e.g., 0.2% of the highest module voltage. The activation difference can therefore optionally be dependent on the charging state of the battery modules.

Similarly to the method described above for controlling the discharging, the invention provides a method for controlling the charging of the kind mentioned initially, wherein a lowest module voltage is determined from the determined module voltages and only those battery modules whose module voltage differs from the lowest module voltages by less than a predefined activation difference are interconnected. The above explanations on the activation difference and on the number of battery modules in the group apply similarly for this which is why reference is made to the above paragraphs to avoid repetitions.

Also in connection with the method for controlling the charging, the module voltages and on this basis the interconnected battery modules can be re-determined at regular intervals.

Likewise, according to an optional variant of this method, the predefined activation difference can be less than 1%, in particular less than 0.5% of the nominal voltage of a battery module.

Optionally in the disclosed method for controlling the discharging, an output power of the group can be dynamically limited depending on the interconnected battery modules. It can thereby be achieved that the individual battery modules do not exceed a predefined maximum discharging current. The limitation can be provided, for example, as dynamic power regulation of a load, e.g., of an electric motor. For example, a controller can check how many battery modules with the same maximum discharging current are connected and connected in parallel and regulate a maximum output power provided depending on this. For example, in the case of two interconnected (active) battery modules a motor power of, e.g., 1000 W can be provided. As soon as a third battery module is connected, the motor power provided can be raised, e.g., to 1500 W. If, on the other hand, a battery module is separated or disconnected earlier, the maximum motor power provided can be reduced, e.g., to 500 W. If the battery modules have different maximum discharge currents, the controller can request the respective maximum discharge currents via the data bus and adapt the limitation of the output power accordingly. The dynamic limitation described can on the one hand protect the cells of the battery modules and at the same time a maximum output power can be provided.

Similarly to this, in the disclosed method for controlling the charging, a charging current of the group can optionally be dynamically adapted depending on the interconnected battery modules. As a result, a minimum charging time of the entire group can be achieved.

With regard to a battery module of the kind mentioned initially, the invention provides that the battery module has a module controller connected to the voltage measuring device and the switch, wherein the module controller has at least one data bus connection and is adapted, when connected to a data bus, to provide a voltage determined by the voltage measuring device on the data bus and to open the switch in response to a control command received on the data bus. The battery module can thus be adapted to participate in one of the methods described above. The data bus can in this case be formed by any type of data transmission between the module controller and a group controller. In particular, this data transmission is not restricted to specific physical media. In addition, the data bus is not restricted to a single line or frequency, for example, the transmission of the module voltage and the transmission of the control command could take place on different lines or frequencies which in this case would be understood together as data bus.

According to an optional exemplary embodiment, the battery unit comprises at least one lithium-ion cell. This battery technology is prone to heating in the case of significant equalizing currents between several battery modules. In this connection, the invention therefore achieves an additional safety effect to avoid excessive heating of the battery modules or to limit the heating of the battery modules during operation. This applies in particular in view of the fact that battery modules can be combined in very different charging states.

The data bus can be a serial data bus, in particular according to RS-485 or CAN bus. An advantage of a serial data bus is the simple and flexible extendibility and configurability of the group of battery modules. For example, the sequence of battery modules can be arbitrarily selected or varied without necessitating changes to the data bus.

According to an optional exemplary embodiment, the battery module can comprise at least one mechanical coupling for connection to a further battery module, wherein a power connection and a data bus connection are arranged in such a manner that a further battery module connected via the mechanical coupling participates on the same data bus and the two battery modules are interconnectable in parallel. For example, a screw connection or a bayonet connection or a connection with snap or hook elements can be provided as mechanical coupling. For example, the battery module can have at least two mechanical couplings so that the group can be formed by a succession or linking of several (e.g. three or more) battery modules.

The mechanical coupling can, for example, comprise a thread. More precisely, for example, an external thread can be provided on one side of the battery module and a rotatable screw ring having an internal thread can be provided on an opposite side of the battery module. In this way, several battery modules can be screwed together.

Furthermore the battery module can be suitable for use under water. For this purpose, the battery module can have a housing that is waterproof up to a defined depth in which the battery unit is accommodated. Any mechanical coupling can enable a corresponding waterproof connection between adjacent battery modules and for example, be fitted with a corresponding seal.

The at least one power connection and/or the at least one data bus connection can comprise spring-loaded electrical contacts. The contacts can, for example, be designed to be protected from spray water. Optionally the contacts can be adapted in such a manner that an electrical contact can only be made in the case of a mechanical connection with a neighbouring battery module whereas otherwise the electrical contacts are shielded in a watertight manner.

According to a further exemplary embodiment, the battery unit can have a maximum energy content of 100 Wh. A lower energy content allows a relatively safe transport, for example, in an airplane.

Furthermore, the battery module can optionally have a carrying device, in particular a handle. The individual battery modules can thus be transported comfortably and safely.

A housing of the battery module can, for example, be made of metal, in particular of aluminium. The housing can alternatively or additionally be made of plastic.

The invention further provides a group of the kind mentioned initially wherein the individual battery modules are designed according to one of the above variants.

Finally the invention provides a load module of the kind mentioned initially, wherein the load module has a group controller with a data bus connection, wherein the group controller is adapted to receive determined module voltages from connected battery modules when connected to a data bus, to determine a highest module voltage from the received module voltages and to send a control command for parallel switching only to those battery modules whose module voltage differs from the highest module voltage by less than a predefined activation difference. The load module can, for example, comprise a motor, for example, for progressive motion, in particular under water (e.g., for a diver propulsion vehicle). In general, the load module will comprise an electrical consumer or be connected to an electrical consumer which as electrical load can be supplied with electrical energy by one or more of the battery modules of the group. The group controller controls which battery modules are interconnected at which time and are connected to the electrical load and therefore discharged.

Optionally the group controller of the load module can be further adapted to dynamically limit an output power of a connected group of battery modules depending on the interconnected battery modules. Some examples and advantages in this connection have already been described with reference to the method described above for controlling the discharging, to which reference is made here to avoid repetitions.

Similarly to the above load module, the invention provides a charging device of the kind mentioned initially wherein the charging device has a group controller with a data bus connection, wherein the group controller is adapted to receive determined module voltages from connected battery modules when connected to a data bus, to determine a lowest module voltage from the received module voltages and to send a control command for parallel switching only to those battery modules whose module voltage differs from the lowest module voltage by less than a predefined activation difference. In this case, the group controller controls which battery modules are interconnected at which time and are connected to the electrical voltage source of the charging device.

Optionally the group controller of the charging device is further adapted to dynamically adapt a charging current for a connected group of battery modules depending on the interconnected battery modules. The advantages in this connection have already been described with reference to the method described above for controlling the charging to which reference is made here to avoid repetitions.

The invention will be described in further detail hereinafter with reference to optional exemplary embodiments to which it should not however be restricted and with reference to the drawings. In the drawings in detail:

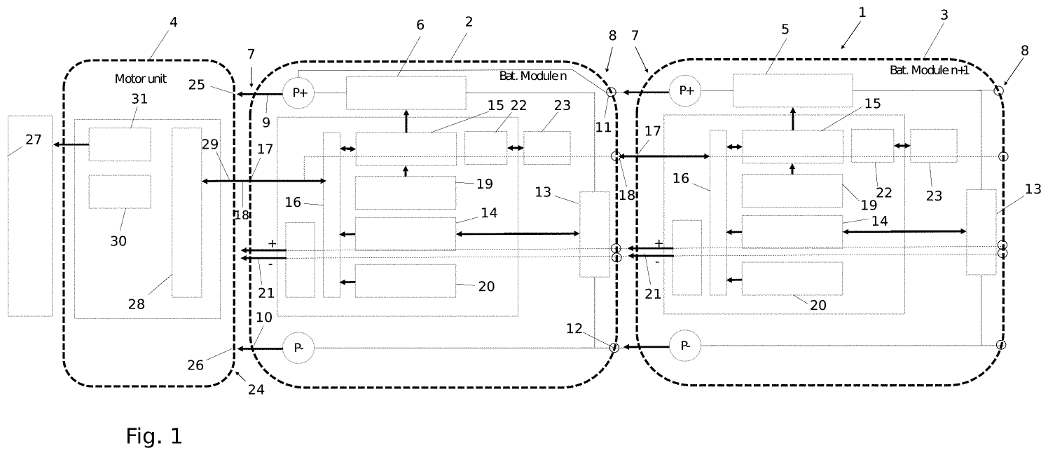

FIG. 1 schematically shows a block diagram with a group of two battery modules and a load module connected thereto;

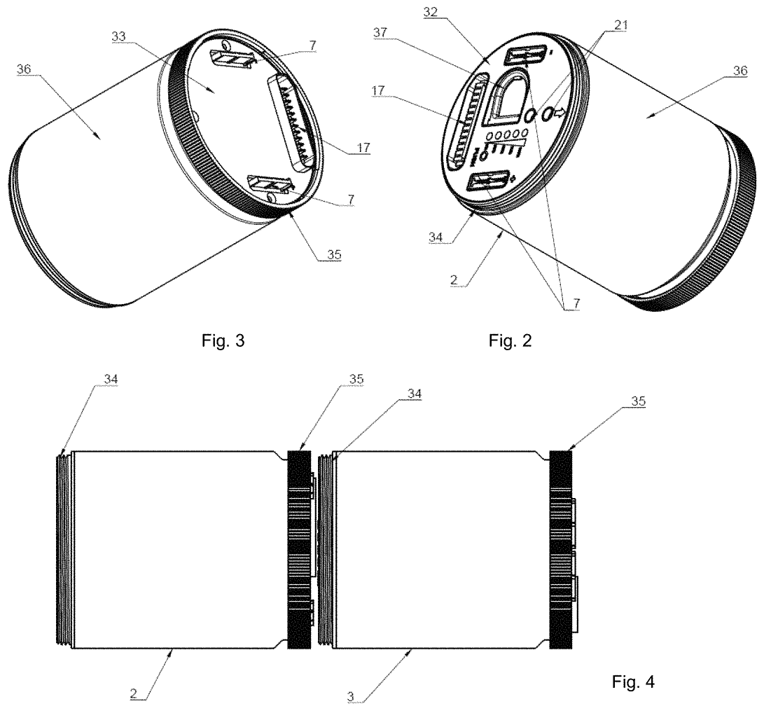

FIG. 2 schematically shows a diagrammatic view of a battery module with the viewing direction onto a front side;

FIG. 3 schematically shows a diagrammatic view of a battery module according to FIG. 2 with the viewing direction onto a rear side;

FIG. 4 schematically shows a side view of two consecutively aligned battery modules directly before a mechanical connection of the battery modules; and

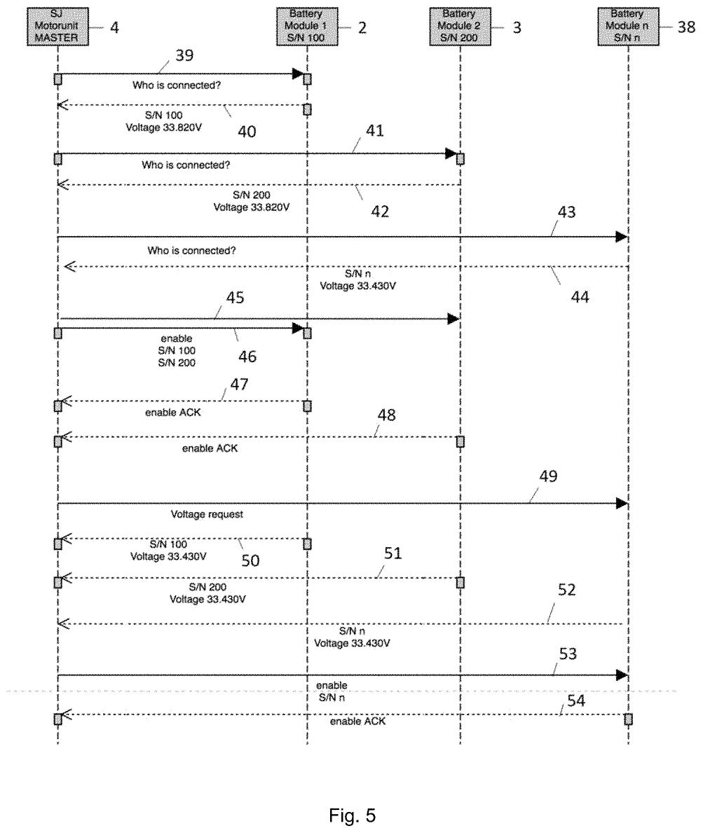

FIG. 5 shows schematically a sequence diagram to show a method for controlling the discharging of a group of three battery modules.

FIG. 1 shows schematically a circuit diagram of a group 1 comprising a first battery module 2 and a second battery module 3 as well as a load module 4 connected to the group 1. The two battery modules 2, 3 are interconnectable in parallel. For this purpose, each battery module 2, 3 has a switch 5, 6. If the switches 5, 6 are closed, the battery modules 2, 3 are interconnected in parallel.

Each battery module 2, 3 has two power connections 7, 8 with respectively two electrical contacts 9, 10, 11, 12. Respectively one battery unit 13 is connected to the power connections 7, 8 via the respective switch 5, 6. The battery units 13 each comprise a plurality of lithium-ion cells. Overall, each battery unit 13 has a specific maximum energy content, e.g., about 100 Wh.

The battery modules 2, 3 have a voltage measuring device 14 for measuring the voltage of the battery unit 13. One module controller 16 is connected to the voltage measuring device 13 and the switch 5, 6, more precisely a driver 15 for the switches 5, 6, respectively. The module controller 16 has a data bus connection 17. The module controller 16 is adapted in this case to provide a voltage determined by the voltage measuring device 14 on the data bus 18 when connected to a data bus 18 and to open (or close) the switch 5, 6 of the relevant battery module 2, 3 in response to a control command received on the data bus 18. The data bus 18 is a serial data bus according to RS-485. The two battery modules 2, 3 participate on the same data bus 18.

In addition, a short-circuit protective circuit 19 is connected to the driver 15. The module controller 16 is additionally connected to a temperature monitor 20 which is adapted for monitoring the temperature of the battery unit 13. The module controller 16 can provide a temperature of the battery unit 13 obtained by the temperature monitor 20 on the data bus 18. The data bus 18 has separate supply lines 21 for supplying power to the bus participants. For displaying the charging state, each of the battery modules 2, 3 has an LED display 22 with a series of LEDs 23.

The load module 4 is connected to the group of battery modules 2, 3. This module has a power connection 24 with two electrical contacts 25, 26 and an electrical load connected therewith in the form of an electric motor 27. The load module 4 has a group controller 28 connected to the data bus 18 with a data bus connection 29. The group controller 28 is adapted to receive determined module voltages from the connected battery modules 2, 3, to determine a highest module voltage from the received module voltages and to send a control command for parallel switching only to those battery modules 2, 3 whose module voltage differs from the highest module voltage by less than a predefined activation difference. The group controller 28 is connected to a charge state monitor 30. The load module 4 has a motor control unit 31 for regulating the direction of rotation and speed of the electric motor 27.

FIGS. 2 to 4 show schematically an exemplary mechanical configuration of a single battery module 2 (FIGS. 2 and 3) or two battery modules 2, 3 (FIG. 4) for use under water. The battery module 2 has a mechanical coupling 34, 35 for connection to a further battery module 3 both on a front side 32 and on a rear side 33. The power connection 7 and the data bus connection 17 are arranged in such a manner that a further battery module 3 connected via the mechanical coupling 34, 35 participates on the same data bus 18 and the two battery modules 2, 3 are interconnectable in parallel (as according to FIG. 1). Both mechanical couplings 34, 35 each have a thread. The data bus connections 17 comprise spring-loaded electrical contacts.

The housing 36 of the battery module 2 can, for example, be made of aluminium. A carrying device in the form of a foldable handle 37 is provided on the housing 36.

The sequence diagram shown in FIG. 5 illustrates the communication between the load module 4 and the battery modules 2, 3, 38. The messages shown in the sequence diagram are exchanged via the data bus 18. The load module 4, more precisely the group controller 28, after activation of the load module 4 sends a request 39 via the data bus 18 to connected battery modules. The first battery module 2 that receives the request 39 sends an acknowledgement 40. The acknowledgement 40 comprises the serial number (e.g., “100”) and the current module voltage (e.g., “33.820 V”) of the battery module 2. After the first acknowledgement 40, the group controller 28 sends a further request 41. The first battery module 2 does not respond again on account of the acknowledgement 40 that has already been sent. The request 41 then arrives at the second battery module 3 as the next one, which then sends a second acknowledgement 42 to the group controller 28. The second acknowledgement 42 contains the serial number (e.g., “200”) and the current module voltage (e.g., “33.820 V”) of the second battery module 3. As a result of the renewed acknowledgement 42, the group controller sends a third request 43 which is answered by the third battery module 38 with its serial number (e.g., “n”) and module voltage (e.g., “33.430 V”) (acknowledgement 44). The group controller 28 compares the module voltages obtained and determines the highest module voltage (here, e.g., “33.820 V”). On this basis those battery modules whose module voltage lies within an activation difference of, e.g., 0.1 V, i.e., in a voltage range of 33.720 V to 33.820 V, is activated. In the example described here the module voltages of the first and second battery module 2, 3 lie within this range. Thus, control commands 45, 46 are sent to the first and the second battery module 2, 3 in order to interconnect these battery modules 2, 3. The two activated battery modules 2, 3 then send activation confirmations 47, 48 back to the group controller 28.

The following part of the sequence diagram shows an alternative sequence for a later point in time when only one request 49 is sent by the group controller 28 which reaches all the battery modules 2, 3, 38. Each of the battery modules 2, 3, 38 then sends an acknowledgement 50, 51, 52 with its serial number and module voltage back to the group controller 28. At this time the module voltage of the first and second battery module has decreased, e.g., to 33.430 V. The module voltage of the third battery module 38 now lies within the activation difference and the third battery module 38 is therefore activated by control command 53 from the group controller 28. After its activation this module sends a confirmation 4 back to the group controller 28.

1. A method for controlling the discharging of a group of one or more battery modules interconnectable in parallel, wherein the module voltages of the battery modules are determined, wherein a highest module voltage is determined from the determined module voltages and only those battery modules whose module voltage differs from the highest module voltage by less than a predefined activation difference are interconnected.

2. The method according to claim 1, wherein the module voltages and on this basis the interconnected battery modules are re-determined at regular intervals.

3. The method according to claim 1, wherein the predefined activation difference is less than 1% of the nominal voltage of a battery module.

4. The method according to claim 1, wherein an output power of the group is dynamically limited depending on the interconnected battery modules.

5. A method for controlling the charging of a group of one or more battery modules interconnectable in parallel, wherein the module voltages of the battery modules are determined, wherein a lowest module voltage is determined from the determined module voltages and only those battery modules whose module voltage differs from the lowest module voltages by less than a predefined activation difference are interconnected.

6. The method according to claim 5, wherein the module voltages and on this basis the interconnected battery modules are re-determined at regular intervals.

7. The method according to claim 5, wherein the predefined activation difference is less than 1% of the nominal voltage of a battery module.

8. The method according to claim 5, wherein a charging current of the group is dynamically adapted depending on the interconnected battery modules.

9. A battery module for use in a group of at least two battery modules interconnectable in parallel, wherein the battery module has at least one power connection and a battery unit connected thereto via a switch, wherein the battery module furthermore has a voltage measuring device for measuring the voltage of the battery unit, wherein the battery module has a module controller connected to the voltage measuring device and the switch, wherein the module controller has at least one data bus connection and is adapted, when connected to a data bus, to provide a voltage determined by the voltage measuring device on the data bus and to open the switch in response to a control command received on the data bus.

10. The battery module according to claim 9, wherein the battery unit comprises at least one lithium-ion cell.

11. The battery module according to claim 9, wherein the data bus is a serial data bus, according to RS-485 or CAN bus.

12. The battery module according to any claim 9, wherein the battery module comprises at least one mechanical coupling for connection to a further battery module, wherein a power connection and a data bus connection are arranged in such a manner that a further battery module connected via the mechanical coupling participates on the same data bus and the two battery modules are interconnectable in parallel.

13. The battery module according to claim 12, wherein the mechanical coupling comprises a thread.

14. The battery module according to claim 9, wherein the battery module is suitable for use under water.

15. The battery module according to claim 9, wherein the at least one power connection and/or the at least one data bus connection comprise spring-loaded electrical contacts.

16. The battery module according to claim 9, wherein the battery unit has a maximum energy content of 100 Wh.

17. The battery module according to claim 9, wherein the battery module has a carrying device comprising a handle.

18. A group comprising at least two battery modules according to claim 9, wherein the battery modules are participants on the same data bus and are interconnectable in parallel.

19. A load module for connection to a group of one or more battery modules interconnectable in parallel, wherein the load module has a power connection and an electrical load connected thereto, characterized in that the load module has a group controller with a data bus connection, wherein the group controller is adapted to receive determined module voltages from connected battery modules when connected to a data bus, to determine a highest module voltage from the received module voltages and to send a control command for parallel switching only to those battery modules whose module voltage differs from the highest module voltage by less than a predefined activation difference.

20. The load module according to claim 19, wherein the group controller is further adapted to dynamically limit an output power of a connected group of battery modules depending on the interconnected battery modules.

21. A charging device for connection to a group of one or more battery modules interconnectable in parallel, wherein the charging device has power connections and an electrical voltage source connected thereto, wherein the charging device has a group controller with a data bus connection, wherein the group controller is adapted to receive determined module voltages from connected battery modules when connected to a data bus, to determine a lowest module voltage from the received module voltages and to send a control command for parallel switching only to those battery modules whose module voltage differs from the lowest module voltage by less than a predefined activation difference.

22. The charging device according to claim 21, wherein the group controller is further adapted to dynamically adapt a charging current for a connected group of battery modules depending on the interconnected battery modules.
